(19) United States
(12) Patent Application Publication
(10) Pub. No.: US 2014/0223816 A1
(43) Pub. Date: Aug. 14, 2014

(54) VERTICAL GARDENING APPARATUS

(71) Applicant: Bobby M. Parker, Strawberry Plains, TN (US)

(72) Inventor: Bobby M. Parker, Strawberry Plains, TN (US)

(21) Appl. No.: 14/177,669

(22) Filed: Feb. 11, 2014

Related U.S. Application Data
(60) Provisional application No. 61/763,697, filed on Feb. 12, 2013.

(51) Int. Cl. A01G 27/00

(52) U.S. Cl. CPC A01G 27/006; A01G 27/003
USPC 47/82

(57) ABSTRACT

A vertical gardening apparatus for supporting the growth of a plurality of plants in a vertical array. The apparatus includes a hollow, plant growth chamber for receiving a planting medium. A plurality of planting ports are formed in the wall of the growth chamber to provide aeration and access for plants to be planted in the planting medium. A water distribution system is provided for delivering water and plant nutrients to the planting medium and includes an external water line assembly that distributes water from a water source to an internal conduit housed within the plant growth chamber.

### RELATED APPLICATIONS

This application claims priority to U.S. provisional patent application Ser. No. 61/763,697 filed Feb. 12, 2013, the contents of which are incorporated herein by reference.

### FIELD

The present disclosure relates generally to the technical field of horticulture. More particularly, the present disclosure relates to an apparatus for plant cultivation and the construction thereof.

### BACKGROUND

Vertical planters and vertical hydroponic planting systems for growing plants or flowers in a vertical array are desirable under conditions where there is insufficient outdoor space for conventional gardening and land is at a premium, or the natural soil is not suitable for plant growth. Among its advantages, a vertical gardening apparatus is used to facilitate a maximum volume of plant growth in a minimum environmental area.

One challenge presented by vertical or columnar planters is supplying the planting medium with an adequate and evenly distributed moisture level necessary for enabling good plant growth. Prior vertical planter devices tend to be complex, difficult to manufacture, require a separate electric power source, and are not conducive to irrigating large vertical gardening structures for use in outdoor environments. Many of the known vertical planters do not account for limitations on the lack of accessible power.

Accordingly, there is a need for a vertical gardening apparatus with a water distribution system which is inexpensive to manufacture, easy to assemble, simple to use, and does not require a constant source of electricity to function properly.

### SUMMARY

The aforementioned and other needs are fulfilled by one or more aspects of the present disclosure. The present disclosure relates to a vertical gardening apparatus for growing plants or flowers. In one aspect, the vertical gardening apparatus comprises an outer elongate, planting structure (hereinafter “plant growth chamber” or “growth chamber”) that is oriented vertically when used for growing plants; an inner vertical tube (hereinafter “internal conduit”) of lesser diameter; and a water line assembly, which is connected at one end to a water source (e.g., a water spigot via a section of a water hose) and at the other end, to the internal conduit through an inlet hole in the cap that covers the top end of the outer chamber.

Both the plant growth chamber and the internal conduit are each constructed from a single piece of polyvinylchloride (“PVC”) pipe or some other suitable material with tensile strength that is resistant to destruction by environmental conditions such as rain, sun, heat, or cold.

The vertical plant growth chamber possesses a hollow interior for receiving soil or other planting medium and has a plurality of planting ports or apertures formed in the side walls of the chamber. The port diameter is large enough to provide access for inserting seeds or plant roots into the planting medium within the growth chamber and to allow atmospheric oxygen to permeate the planting medium for the purpose of achieving sufficient aeration to support root formation and plant growth. In order to access needed sunlight and additional space for growth, the branches and foliage of the plants eventually extend through the ports in an outward direction relative to the plant growth chamber.

The internal conduit is centrally positioned within the growth chamber and extends axially through the hollow interior and the surrounding planting medium for channeling fluid from a top end to a bottom end of the growth chamber. A plurality of holes are formed in the wall of the internal conduit to permit the dissemination of water and nutrients to the soil and attendant plant root systems contained in the space between the outside wall of the conduit and the inside wall of the growth chamber.

According to one aspect of the disclosure, the apparatus may include a stopper which is loosely positioned within the internal conduit to the degree that it can be moved up and down the full length of the internal conduit, but the stopper is capable of blocking the majority of fluid flow through the internal conduit. Movement of the stopper within the conduit is achieved manually by using a wire, nylon string, or similar material attached to the stopper. The stopper provides a means for fine adjustment of the regulation of fluid flow within the internal conduit and allows the user to better control the level of fluid saturation in the surrounding planting medium.

Another aspect of the disclosure includes an external and easily adaptable water line assembly that comprises a multiplicity of pipes and pipe fittings in connection to a water source via, for example, a portion of a conventional garden hose. The water line assembly is constructed from a similar material as the internal conduit and plant growth chamber. The water line assembly connects the water source in fluid communication to the internal conduit for directing fluid from the water source downward through the conduit. In one embodiment, the water line assembly may include a control valve located nearest the end where the water line assembly connects to the water source; the valve serves to regulate the flow rate of water and nutrients through the water line assembly and into the internal conduit.

It is, therefore, a primary object of this disclosure to provide a vertical gardening apparatus with a water distribution system that is inexpensive to manufacture, easy to assemble, simple to use, capable of multiple levels of fluid flow regulation, and adaptable to large-scale gardening use.

### BRIEF DESCRIPTION OF THE DRAWINGS

Further features, aspects, and advantages of the present disclosure will be clarified by reference to the following detailed description when considered in conjunction with the figures, which are not necessarily drawn to scale so as to more clearly show the details, wherein like reference numbers indicate like elements throughout the several views, and wherein:

FIG. 1 is a perspective view of a vertical gardening apparatus according to one embodiment of the disclosure;

FIG. 2 is an enlarged perspective view of the adjustable control valve which allows regulation of the amount of water flow from the water source to the water line assembly connected to the plant growth chamber; and

FIG. 3 is a perspective, partial, cutaway view of the cylindrical plant growth chamber from FIG. 1 showing the interface of the internal conduit with the planting medium within the cavity of the plant growth chamber.

### DETAILED DESCRIPTION

Various embodiments of a vertical gardening apparatus are described more fully hereinafter with reference to the accompanying drawings, in which some, but not all embodiments of the disclosure are illustrated in the figures. Indeed, the vertical gardening apparatus may be embodied in many different forms and should not be construed as limited to the embodiments set forth herein; rather, these embodiments are provided so that this disclosure will satisfy applicable legal requirements.

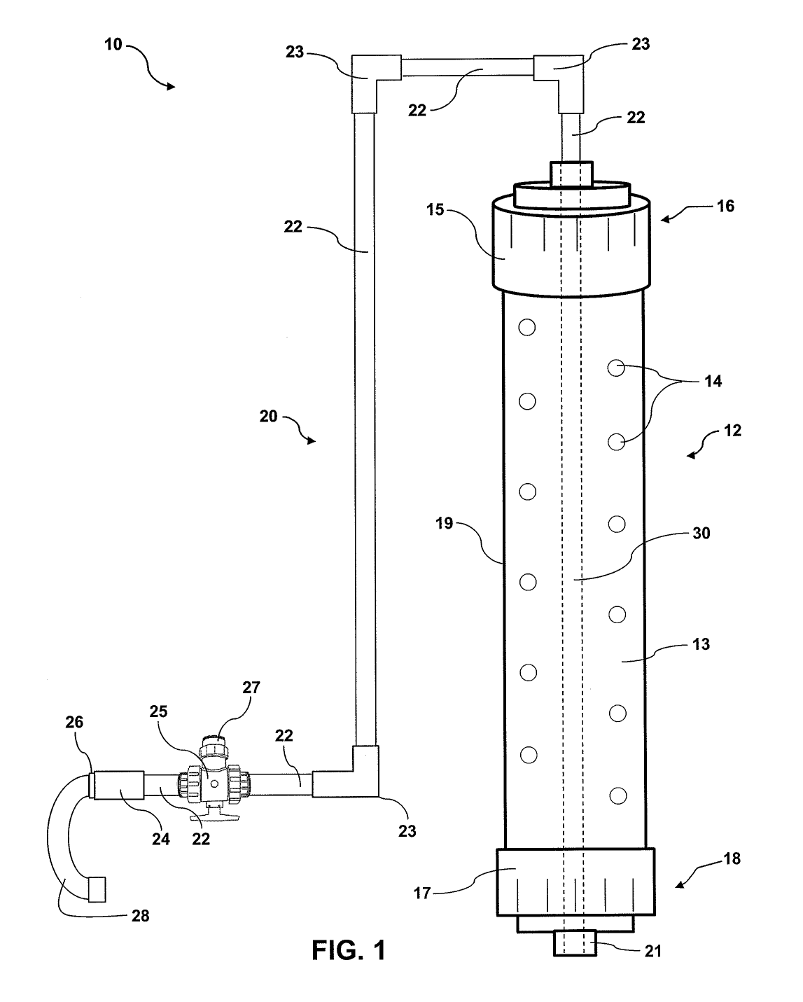

FIG. 1 shows a vertical gardening apparatus 10 in an assembled state according to one embodiment. The apparatus 10 includes a plant growth chamber, designated generally as 12, in connection with an external water line assembly, designated generally as 20. The growth chamber 12 provides housing and support for the cultivation of plants just as a conventional ground-based garden would except that the growth chamber 12 allows the plants to be positioned in a vertical array rather than horizontally as in a conventional garden. The vertical array makes it possible to cultivate a larger number and wider variety of plants in locales where space may be limited.

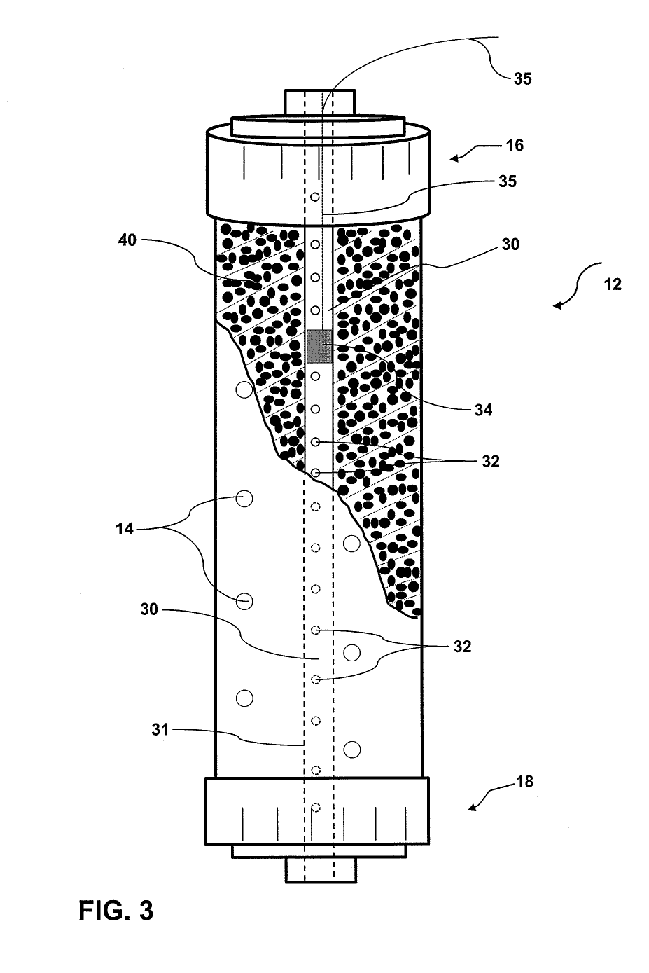

In more detail, still referring to FIG. 1, the principal structural elements of the growth chamber 12 include an elongate planting column 13, oriented vertically when in use. Although illustrated in this embodiment as cylindrical in shape, the growth chamber 12 could also be configured as rectangular, polygonal, or pyramidal (three-sided). The chamber is constructed and configured with a hollow interior for receiving a planting medium, which is shown as 40 in FIG. 3. Referring again to FIG. 1, cylindrical side walls 19 of the chamber 12 are thick enough to give the column 13 tensile strength along its vertical axis, but thin enough so that a plurality of apertures or planting ports, designated generally as 14, can be easily drilled or punched therethrough. The planting ports 14 are used principally for the insertion of seeds or plant roots into a planting medium 40 (as shown in FIG. 3), for aeration, and for allowing growing plants to access sunlight. A central cylindrical conduit 30 (FIGS. 1 and 3), is in fluid communication with the water line assembly 20. The internal conduit 30 is positioned within the growth chamber 12 and extends axially through the hollow interior and the surrounding planting medium for channeling fluid from a top end 16 to a bottom end 18 of the growth chamber 12, thus providing a continuous fluid passageway through the entire growth chamber 12. The internal conduit 30 need not be centrally positioned within the growth chamber 12.

In one embodiment, the multiple planting ports 14 serve as plant-growing locations. When in use for growing plants, the growth chamber 12 is filled with a planting medium (depicted as 40 in FIG. 3), which allows plants to grow in the planting ports 14 with the plant roots established in the planting medium (depicted as 40 in FIG. 3) within the growth chamber 12 and the plant branches and foliage extending through the planting ports 14 to the outside of the growth chamber 12.

In further detail, still referring to FIG. 1, the growth chamber 12 is open at both its top end 16 and bottom end 18. The top end 16 and bottom end 18 of the planting column 13 may be fitted with a removable top cap 15 and a removable bottom cap 17, respectively. The bottom cap 17 contains an adjustable closure 21 through which the flow of water out of the growth chamber 12 is regulated. The adjustable closure 21 primarily allows drainage of excess water from the growth chamber 12 so that plant roots are not exposed to too much water. In one embodiment, the top cap 15 is fitted to the top end 16 of the planting column 13 and serves to prevent rainwater from entering the growth chamber 12 and over-saturating the contents of the growth chamber 12. The top cap 15 contains a bore through which a small-diameter pipe 22 runs from the water line assembly 20 into the planting column 13 where the small-diameter pipe connects to the internal conduit 30. In another embodiment, the planting column 13 is deployed without the top cap 15; this is particularly useful where the user wishes to amend water supplied from the water assembly 20 with rainwater. In such case, the small-diameter pipe 22 runs from the water line assembly 20 directly into the planting column 13 where the small-diameter pipe connects to the internal conduit 30 without intervention by the top cap 15 and the small bore hole therein.

Still referring to FIG. 1, the water line assembly 20 comprises a multiplicity of hollow, small-diameter pipes 22, 90-degree elbow fittings 23, and threaded-sleeve socket fittings 24 operatively joined together to form an assembly that connects the internal conduit 30 (FIGS. 1 and 3) positioned within the growth chamber 12 to an external water source. Preferably, the water line assembly 20 is connected to a conventional outdoor water spigot via the female thread connection 26 of a conventional garden hose 28. A ball valve, designated generally as a control valve at 25, is included along the water line assembly 20 to control the fluid flow.

The construction details of the vertical gardening apparatus 10 as shown in FIG. 1 are that the walls 19 of the growth chamber 12 are formed of polyvinylchloride (“PVC”) pipe or a similar plastic or fiberglass material. Alternatively, the growth chamber 12 can be formed of metal or bamboo. The water line assembly 20 is preferably constructed of PVC pipe or a similar plastic or fiberglass material. The growth chamber 12 can be constructed in a variety of sizes. Furthermore, the vertical gardening apparatus 10 can be configured with only a single growth chamber 12 module or may be configured with any suitable number of growth chamber modules.

In one embodiment, the growth chamber 12 is stabilized in a vertical orientation by placing the bottom end 18 in the ground at least one foot below ground level. The water line assembly 20 is stabilized by clamping a portion of the piping in proximity with the ground to a stake or pipe inserted into the ground.

In an alternate embodiment, the vertical gardening apparatus 10 may be installed by hanging the plant growth chamber 12 from a tree limb or support frame instead of placing the growth chamber portion of the vertical gardening apparatus directly into the ground. Other alternative embodiments within the scope of the present disclosure will occur to those skilled in the art. For example, in yet another embodiment, the plant growth chamber may be mounted on a base that sits on ground level. This base may be constructed of concrete, metal, or wood.

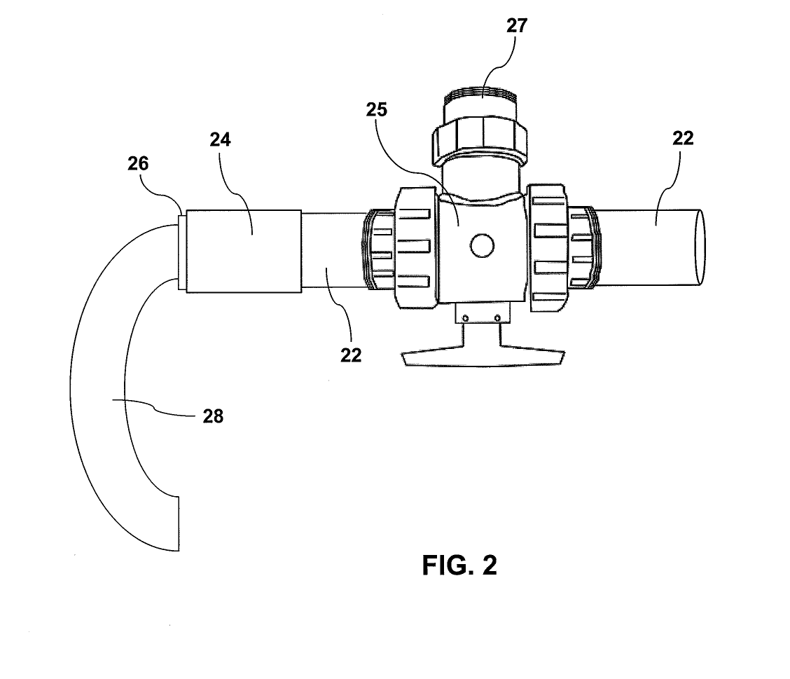

Referring now to FIG. 2 and as noted above, a control valve 25 is operatively associated with the water line assembly 20 and accordingly, the internal conduit 30 for selectively regulating the amount of fluid flow from the water source through the internal conduit 30. In one embodiment, the control valve 25 is a three-way valve in which one port, extending in an upward direction, is open and accessible to receiving plant food or nutrient fluid, designated in FIG. 2 as 27 and called the nutrient-source inlet. The other two openings of the three-way control valve 25 are integrally formed with the water line assembly 20 and directly function in communicating fluid from the water source to the internal conduit 30. The three-way control valve 25 is adjustable so that the flow of water and nutrients can be adjusted relative to one another, or both can be turned fully on or completely off. In this manner, the user can adjust the amount of nutrients and water that flow to the growth chamber 12 without the need for a source of electricity and without the need to manually attend to the vertical gardening apparatus 10 for an extended period of time by manually pouring water and nutrients through the top end 16 of the growth chamber 12. The nutrient-source inlet 27 also can be used to visually assess the amount of water flowing through the water line assembly 20.

In more detail, still referring to FIG. 2, one opening of the three-way control valve 25 is connected to a threaded sleeve socket fitting 24 via a section of small-diameter pipe 22. The sleeve socket fitting 24 is attached to a conventional female hose bib 26 by coupling the female hose bib 26 into the threaded portion of the sleeve socket 24. The other end of the hose 28, in turn, is connected to a conventional water spigot. Another opening of the three-way control valve 25 connects the three-way valve 25 to the major portion of the water line assembly 20. Various alternative arrangements involving different types of valves and piping may be used to accomplish the task of supplying and controlling the flow of water and nutrients to the growth chamber 12. The embodiment discussed above and illustrated in the figures is only one example, which is considered a cost-effective method to accomplish this task.

Referring now to FIG. 3, which provides a partial cutaway view of the growth chamber 12, the internal conduit 30 within the growth chamber 12 is shown in association with a continuous column of soil or another planting medium 40. Preferably, the planting medium 40 installed in the growth chamber 12 will be somewhat cohesive, in the nature of soil such as humus. In one embodiment, the cylindrical walls 31 of the internal conduit 30 contain fluid distribution holes 32 that are approximately 3/32″ in diameter and are positioned at approximately every 8″ from the top of the internal conduit to the bottom of the internal conduit. At every 8 inches along the internal conduit 30, there are 4 fluid distribution holes 32 equidistantly positioned around the circumference of the internal conduit 30. Water and plant nutrients are conveyed by the water line assembly 20 (shown in FIG. 1) to the internal conduit 30, which then distributes the fluid to the surrounding planting medium 40 though the plurality of holes 32 in the internal conduit walls.

Still referring to FIG. 3, advantageously, the degree of fluid saturation in the surrounding planting medium 40 can be further controlled by adjusting the position of a stopper 34 within the internal conduit 30. The diameter of the stopper 34 is slightly less than the diameter of the inner cavity of internal conduit 30 such that the stopper 34 can move up and down freely within the internal conduit 30 while still significantly impeding the free flow of water and nutrients. The stopper 34 thus provides a second level of control over the amount of water and nutrients delivered to the growth chamber 12 and, furthermore, provides a means for controlling the amount of water and nutrients supplied to the different levels of the planting medium 40. A cord 35, which can made of various materials including wire or nylon, is attached to the upper surface of the stopper 34. The cord 35 allows the user to raise and lower the stopper 34 to the desired position within the internal conduit 30. The cord 35 may be of different lengths, but should be at least the vertical length of the internal conduit 30 if the user desires to exercise control over the water and nutrient supply to the full length of the internal conduit 30.

In one embodiment, the internal conduit 30 is a single tube running down the center of the growth chamber 12 from its connection to the water line assembly 20 near the upper portion of the top cap 15. In yet another embodiment, the section of the small-diameter pipe 22 just above the upper portion of the top cap 15 forks into one or more branches, each of which connects independently to a separate internal conduit 30, each with its own stopper 34 and cord 35. The internal conduits are placed at different positions and levels within the growth chamber, thus enabling even greater control over the supply of water and nutrients to different areas of the growth chamber.

Advantages of the vertical gardening apparatus include, without limitation, that it is inexpensive to manufacture, easy to assemble, and adaptable to large-scale, outdoor gardening applications. Of vital importance, operation of the water distribution system does not require a separate electric power source. Further, the water distribution system permits the fluid flow rate to be controlled at multiple levels of regulation to better control the degree of water and plant nutrient saturation of the planting medium.

The foregoing description of embodiments of the present disclosure has been presented for purposes of illustration and description. The described embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated.

What is claimed is:

1. A vertical gardening apparatus comprising:
(a) at least one elongate plant growth chamber having a hollow interior for receiving a planting medium, said growth chamber in a vertical orientation when in use;
(b) a plurality of planting ports formed in the cylindrical walls of said growth chamber, said planting ports providing aeration and access for plants to be planted in said planting medium;
(c) a cylindrical internal conduit positioned within said growth chamber and extending along and through the long axis of said hollow interior and interfacing with said planting medium, wherein said internal conduit contains a plurality of fluid distribution holes for delivering fluid from a top end to a bottom end of said growth chamber; and
(d) a water line assembly operatively connected to said internal conduit for conducting water and plant nutrients from a water and plant nutrient source to plant-growing locations within said growth chamber.

2. The apparatus of claim 1 wherein said growth chamber comprises a top cap and a bottom cap, both of which are capable of being removed for at least the purpose of adding or removing said planting medium.

3. The apparatus of claim 2 wherein said top cap includes a receiving slot adapted to engage a top end of said internal conduit in said growth chamber, wherein said top cap functions to connect said internal conduit with said water line assembly.

4. The apparatus of claim 2 wherein said bottom cap includes a receiving slot adapted to engage a bottom end of said internal conduit in said growth chamber.

5. The apparatus of claim 2 wherein said bottom cap includes at least one drain hole for removing excess fluid from the planting medium.

6. The apparatus of claim 5 wherein said drain hole in said bottom cap of growth chamber is approximately ½″ in diameter and located in the center of said bottom cap.

7. The apparatus of claim 1 wherein said growth chamber is constructed of polyvinylchloride or a similar plastic or fiberglass material.

8. A water distribution system in association with a plant growth chamber for selectively delivering different amounts of fluid to selected regions of the growth chamber, the water distribution system comprising:
(a) a cylindrical internal conduit positioned within said growth chamber and extending along and through the long axis of the hollow interior of said growth chamber and interfacing with a planting medium, wherein said internal conduit contains a plurality of fluid distribution holes for delivering fluid from a top end to a bottom end of said growth chamber as well as areas in between;
(b) a water line assembly comprising a series of hollow pipes and pipe fittings joined together and externally located relative to the growth chamber, wherein said water line assembly channels fluid from a water source to said internal conduit;
(c) a control valve operatively associated with said water line assembly and said internal conduit for selectively controlling the amount of fluid flow from the water source through said internal conduit within the growth chamber; and
(d) a stopper placed within the interior of said internal conduit, said stopper capable of being moved up and down the entire length of said internal conduit by pulling or relaxing a tethering device connected to said stopper, wherein said stopper provides a further means for controlling fluid distribution to the surrounding planting medium.

9. The water distribution system of claim 8 wherein said control valve is a three-way valve having one opening accessible to receiving plant food or nutrient fluid and having the other two openings integrally formed with said water line assembly.

10. The water distribution system of claim 9 wherein said three-way valve is connected at a first opening to a threaded sleeve socket fitting at a first end.

11. The water distribution system of claim 10 wherein said sleeve socket fitting is connected at a second end to a conventional female hose bib having a portion of hose, said hose attached to a water spigot.

12. The water distribution system of claim 9 wherein said three-way valve is connected at a second opening to a pipe comprising said water line assembly.
